(19) United States
(12) Patent Application Publication
(10) Pub. No.: US 2015/0081859 A1
(43) Pub. Date: Mar. 19, 2015

(54) METHOD, APPARATUS AND SYSTEM FOR CONNECTING DEVICES TO A NETWORK

(71) Applicant: INVENTEC APPLIANCES CORP., New Taipei City (TW)

(72) Inventors: Hui-Yan Xu, Jiangxi (CN); Shieng-Ting Kao, New Taipei City (TW); Yuan Hong, Jiangxi (CN); Yang Zhang, Jiangxi (CN)

(21) Appl. No.: 14/328,371

(22) Filed: Jul. 10, 2014

(30) Foreign Application Priority Data
Sep. 17, 2013 (CN) 201310424997.9

(51) Int. Cl. H04L 12/24

(52) U.S. Cl. CPC H04L 41/0806
USPC 709/222

(57) ABSTRACT

The present invention discloses a method, apparatus and system of configuring devices to join a network. The method of the present invention comprises the following steps of: a second device broadcasting in a hot spot of the network; a first device scanning for a broadcasted signal from the second device for connecting the first device to the second device; the first device sending a network configuration information to the second device; and the second device to connect to the network according to the network configuration information. According to the method of the present invention, the devices can be received the network configuration information and configured automatically for joining a network group efficiently.

### PRIORITY CLAIM

This application claims the benefit of the filing date of Chinese Patent Application No. 201310424997.9, filed Sep. 17, 2013, entitled “A METHOD, APPARATUS AND SYSTEM FOR CONNECTING DEVICES TO A NETWORK,” and the contents of which are hereby incorporated by reference in their entirety.

### FIELD OF THE INVENTION

The present invention relates to a wireless communication technique, more particularly, to a method, apparatus and system for connecting devices to a network.

### BACKGROUND

In recent years, the popularization of technology and the Internet have caused wireless communication methods and electronic devices to play a vital role in people's lives. Among these wireless communication methods is the widely adopted use of Wi-Fi, a global standard due to its convenience and stability. People worldwide use their computers, cell phones and other electronic devices to connect to the Internet using Wi-Fi, which allows the interworking of multiple devices on a wireless network. At the same time, the rapid development of internet technology have caused manufacturers to create refrigerators, air conditioners and a multitude of other devices, which previously only had a single function, that have the ability to connect to the Internet to utilize smart control of household electronic appliances.

However, in the prior art, connecting a terminal device to a local area network requires manually configuration of network parameters for the device. Additionally, if the device is trying to connect to a wireless network, the device will need to input the user name and password of the network. If a user has multiple devices, the process of manually configuring the network parameters for each device becomes a major inconvenience. Configuration interface of electronic devices, such as refrigerators, air conditioners or other devices, do not intuitively include an input interface (which is usually a remote controller), causes the configuration of network parameters to be a major inconvenience for the maintenance workers.

Therefore, a method that can automatically configure the network parameters for electronic devices to connect to a network group is needed.

### SUMMARY OF THE INVENTION

The present invention is generally directed to a method, apparatus and system for connecting devices to a network. Using the automatic configuration of the device, an objective of the present invention is for connecting an electronic device to a network group automatically.

In one aspect of the present invention, a method for connecting device to a network includes the steps of (1) scanning for a broadcasted signal from a second device in a hot spot of the network with a first device; (2) connecting the first device to the second device through the broadcasted signal if the broadcasted signal is detected; and (3) sending a network configuration information by the first device to the second device, for the second device to connect to the network according to the network configuration information.

In another aspect of the present invention, a method for connecting device to a network includes the steps of (1) performing a broadcast in a hot spot of the network; (2) connecting to a first device, if detecting a request for connection from the first device through the broadcast; (3) receiving a network configuration information from the first device; and (4) connecting to the network according to the network configuration information.

In yet another aspect of the present invention, an apparatus for connecting device to a network includes a scanning unit used for scanning for a broadcasted signal from a second device in a hot spot of the network; a communication unit used for connecting to the second device if the broadcasted signal is detected; and a data transmitting unit used for sending a network configuration information to the second device for connecting the second device to the network according to the network configuration information.

In still yet another aspect of the present invention, an apparatus for connecting device to a network includes a hotspot broadcast unit, used for performing a broadcast in a hot spot of the network; a communication connecting unit, used for connecting to a first device if detecting a request for connection from the first device through the broadcast; a data receiving unit, used for receiving a network configuration information sent from the first device; and a network connecting unit, used for connecting to the network according to the network configuration information.

As mentioned above, when compared to the prior art, the present invention may conveniently connect a main device to a second device which has just joined the network and send local network identification information to the second device. This allows the main device to join and be configured automatically to reduce the inconvenience of manually inputting network configuration information.

Many other advantages and features of the present invention will be further understood by the following detailed description and the appended drawings.

### BRIEF DESCRIPTION OF THE DRAWINGS

Some of the embodiments will be described in detail, with reference to the following figures, wherein like designations denote like members, wherein:

FIG. 1 is a flow chart of the first method for connecting a device to a network in an embodiment of the invention;

FIG. 2 is a flow chart of the second method for connecting a device to a network in an embodiment of the invention;

FIG. 3 is a flow chart of the third method for connecting a device to a network in an embodiment of the invention;

FIG. 4 is a function block diagram of the first device for connecting a device to a network in an embodiment of the invention;

FIG. 5 is a function block diagram of the second device for connecting a device to a network in an embodiment of the invention;

FIG. 6 is a function block diagram for connecting a device to a network system in an embodiment of the invention;

### DETAILED DESCRIPTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of embodiments of the present invention.

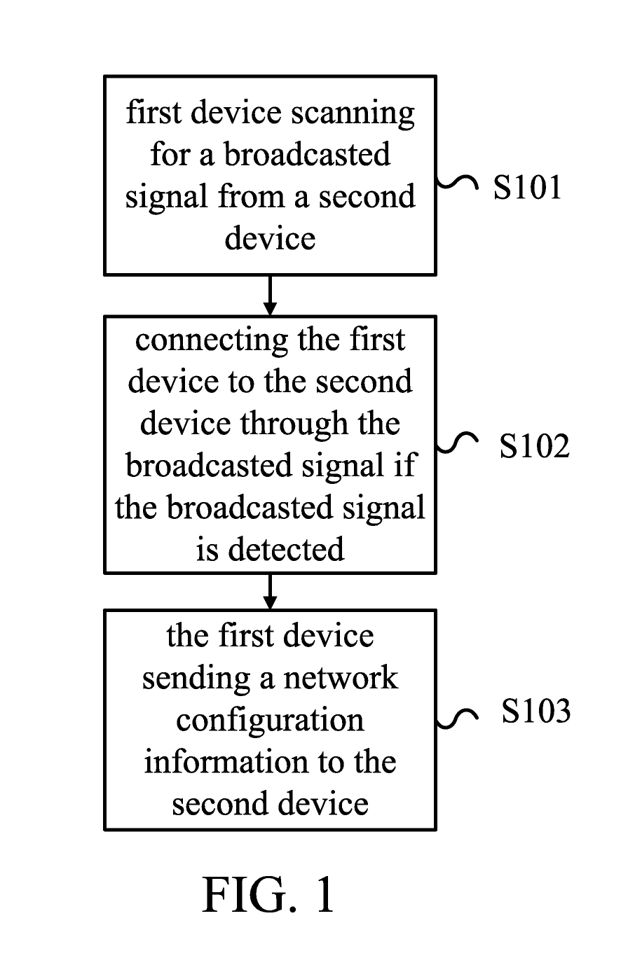

Please refer to FIG. 1. FIG. 1. is a flow chart of the first method for connecting a device to a network in an embodiment of the invention. In this embodiment, the method for connecting a device to a network of the present invention, comprises: (S101) a first device scanning for a broadcasted signal from a second device in a hot spot of the network; (S102) connecting the first device to the second device through the broadcasted signal if the broadcasted signal is detected; and (S103) the first device sending a network configuration information to the second device, for the second device to connect to the network according to the network configuration information.

The first device performs the broadcasted signal of the network hotspot and detects if there has been a broadcasted signal from the second device connected to the network hotspot. The first device connects to the second device through the broadcasted signal if the broadcasted signal from the second device is detected. When connecting to the second device normally, the first device sending the network configuration information to the second device, for the second device to connect to the network according to the network configuration information, wherein the network configuration information includes authentication information of accessing the network or information for connecting to the network. Furthermore, the network configuration information further includes information of the first device's hardware or of upgrading program for the second device. The second device then gets connection information of the local network.

This embodiment comprises the following advantage, a first device scanning for a broadcasted signal from a second device in a hot spot of the network. The first device connects to the second device through the broadcasted signal if the broadcasted signal is detected. The first device sending the network configuration information to the second device for the second device to connect to the network according to the network configuration information if the second device is connected. Through the method mentioned above, the control device can conveniently connect to the device which has just joined the network and send local network identification information to the device that has just joined. It allows the device to join and be configured automatically, which reduces the need for manual operation.

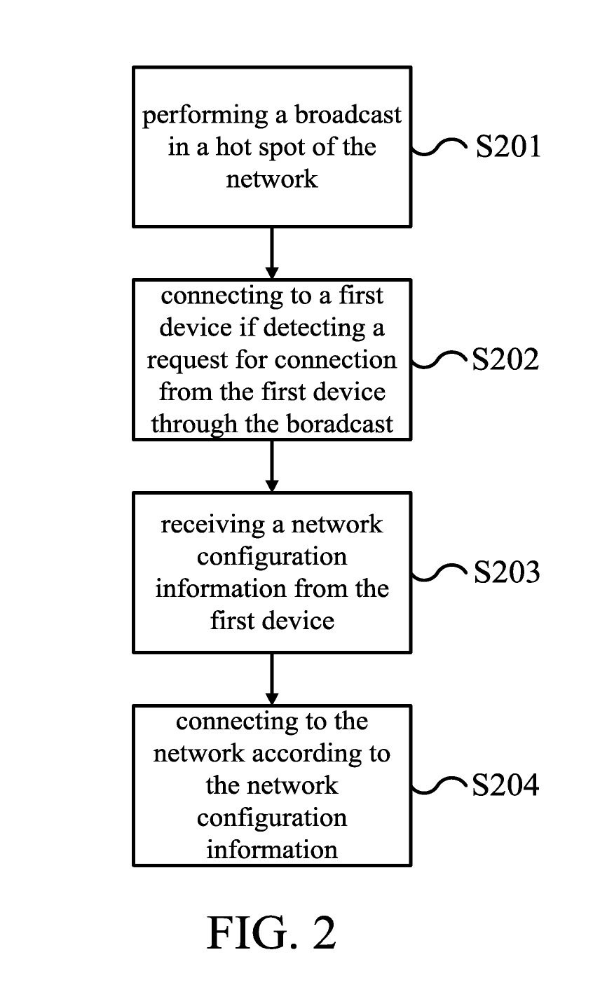

Please refer to FIG. 2. FIG. 2 is a flow chart of the second method for connecting a device to a network in an embodiment of the invention. In this embodiment, the present invention further discloses a method for connecting a device to a network, comprising: (S201) performing a broadcast in a hot spot of the network; (S202) connecting to a first device, if detecting a request for connection from the first device through the broadcast; (S203) receiving a network configuration information from the first device; and (S204) connecting to the network according to the network configuration information.

The second device performs the broadcast in the hot spot to allow other devices to connect and then connects to a first device if detecting a request for connection from the first device through the broadcast. After connecting to the first device, the second device receiving the network configuration information from the first device, wherein the network configuration information includes authentication information of accessing the network or information for connecting to the network. Furthermore, the network configuration information further includes information of the first device's hardware or of upgrading program for the second device. When the second device gets the network configuration information, the second device connects to the network according to the network configuration information, wherein the step of connecting to the network can be connecting to a local Wi-Fi or another local network. The network configuration information can also be used to carry other information, for example, to upgrade the software of the device.

This embodiment comprises: broadcasting a network hotspot; connecting to a first device, if a connection request from the first device is detected through the broadcasted signal; then receiving the network configuration information from the first device; and connecting to the network according to the network configuration information. The advantage of the method mentioned above is that it allows other control devices to send the network configuration information to the second device through the broadcast signal, where the second device then logs in the local network. This allows the device to join and be configured automatically which reduces the amount of manual operation.

Furthermore, the second method for connecting a device to a network in another embodiment of the invention will be described in the following. In this embodiment, after receiving the network configuration information from the first device, the method further comprises stopping the broadcasted signal. When the second device receives the network configuration information from the first device it will then cease the broadcasted signal. If the step of connecting to the network according to the network configuration information fails, then the second device will broadcast the hotspot again. Due to factors from the environment or the device, the network configuration information received by the second device may be not completed. For example, when receiving the network configuration information, there may be signal interference or the transmission may have been interrupted unexpectedly. Therefore, under these conditions, the second device needs to broadcast the hotspot again to allow other devices, such as the first device, to be able to reconnect to the second device to execute the network configuration. When the second device is connected to the first device, the first device sends the network configuration information again and the second device will then connect to the network according to the network configuration information.

This embodiment comprises: upon receiving the network configuration information from the first device, stopping the broadcast, and then connecting to the network according to the network configuration information. If the step of connecting to the network according to the network configuration information fails, then broadcasting the hotspot again. The advantage of the method mentioned above is that the second device can receive the network configuration information from other devices again to improve the self-adjustment of the device for when the first received network configuration information is incorrect.

In addition, the second method for connecting a device to a network in another embodiment of the invention will be described in the following. In this embodiment, after connecting to the network according to the network configuration information, the method further comprises storing the network configuration information. After the second device connects to the network through the network configuration information, the second device can store the network configuration information to use for logging in next time or to send the network configuration information to other devices. The network configuration information can be stored in the second device or sent to a remote device through the network to be stored. If the network configuration information is stored in the remote device, the network configuration information can then be downloaded from the remote device when needed.

In this embodiment, after connecting to the network according to the network configuration information, the method further comprises the steps of: sending the network configuration information to a remote device through the network; and the remote device performing a monitoring operation according to the network configuration information. The network configuration information comprises hardware information, working state or error messages, etc. Therefore, the remote device can receive the corresponding information to monitor the state of the second device. Additionally, the remote device can act as the remote server or the first device. Because the functions of them are similar, it will not be listed here.

This embodiment comprises the following advantages: through the storage of the network configuration information, logging into the local network again becomes more convenient. At the same time, through the sending of the network configuration information to the remote device, the working state of the device can be monitored by the user.

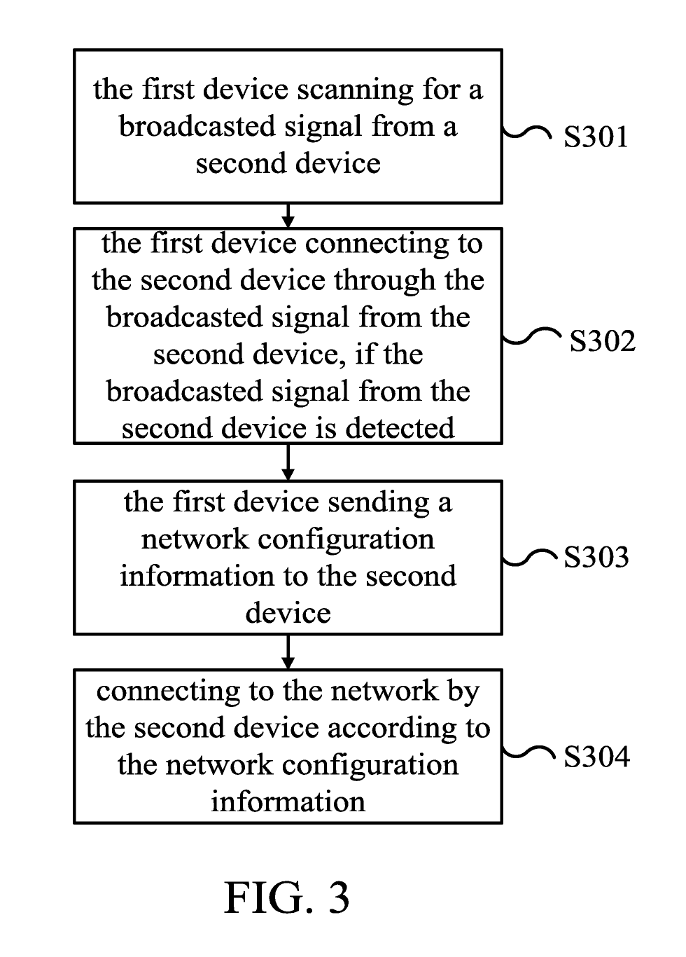

Please refer to FIG. 3. FIG. 3 is a flow chart of the third method for connecting a device to a network in an embodiment of the invention. In this embodiment, the steps for connecting a device to a network comprises: (S301) the first device scanning for a broadcasted signal from a second device in the hot spot of the network; (S302) the first device connecting to the second device through the broadcasted signal from the second device, if the broadcasted signal from the second device is detected; (S303) the first device sending a network configuration information to the second device; and (S304) connecting to the network by the second device according to the network configuration information.

In this embodiment, the second device broadcasts the network hotspot. The first device scanning for a broadcasted signal from a second device in the hot spot. And the first device connects to the second device through the broadcasted signal from the second device, if the broadcasted signal from the second device is detected. After connecting, the first device sending the network configuration information to the second device, wherein the network configuration information includes authentication information of accessing the network or information for connecting to the network. The network configuration information further includes information of the first device's hardware or of upgrading program for the second device. The second device then connects to the network according to the network configuration information. The second device can also execute other operations through the use of other information comprised in the network configuration information, such as using the upgrade program to upgrade the software of the device.

This embodiment comprises: the first device scanning for a broadcasted signal from a second device in the hot spot; the first device connecting to the second device through the broadcasted signal from the second device, if the broadcasted signal from the second device is detected; the first device sending the network configuration information to the second device; and connecting to the network by the second device according to the network configuration information. The advantage of the method mentioned above is that through the broadcasting of the network hotspot, it allows the original device to send the local network configuration information to the device which has just joined the network. The device that just joined can then log onto the local network according to the information comprised in the network configuration information. This allows the device to join and be configured automatically to reduce the amount of manual operation.

Additionally, the third method for connecting a device to a network in another embodiment of the invention will be described in the following. In this embodiment, after the second device connecting to the network according to the network configuration information, the method further comprises: the second device connecting to a third device if a hotspot broadcasted signal from the third device is detected; the second device sending the network configuration information to the third device; and the third device connecting to the network according to the network configuration information. In a practical case, after the second device is connected to the network, the second device can still detect broadcasted signals of the network hotspot from other devices. If the third device broadcasts the network hotspot at the moment and is ready to connect to the network, then the second device detects the broadcasted signal from the third device and then connects to the third device. After the second device connects to the third device, the second device sends the network configuration information to the third device, wherein the network configuration information includes authentication information of accessing the network or information for connecting to the network. And the network configuration information further includes information of the first device's hardware or of upgrading program for the second device. The network configuration information can be the information stored in the second device or the remote device. The third device connects to the network according to the network configuration information. The third device can also execute other operations through other information comprised in the network configuration information, such as using the upgrade program to upgrade the software of the device.

This embodiment comprises: the second device connecting to a third device if a hotspot broadcast from the third device is detected; the second device sending the network configuration information to the third device; and the third device connecting to the network according to the network configuration information. The advantages of the method mentioned above is that through the broadcast of the hotspot, the second device can send the network configuration information automatically to other devices that just joined the network. The device that just joined can then login the network according to the information comprised in the network configuration information. This allows the device to join and be configured automatically and reduces the amount of manual operation.

On the basis of the method for connecting a device to a network mentioned above, the present invention further provides an apparatus and system for connecting a device to a network. They will be illustrated in detail with embodiments in the following.

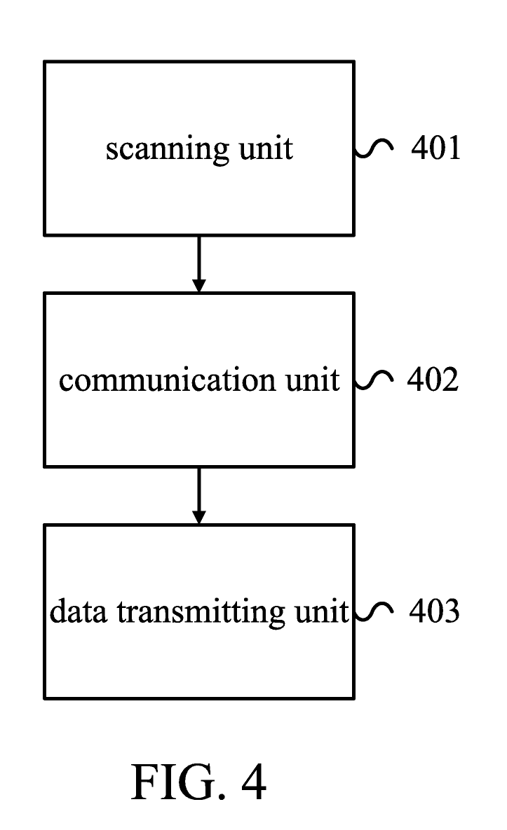

Please refer to FIG. 4. FIG. 4 is a function block diagram of the first device for connecting a device to a network in an embodiment of the invention. In this embodiment, the apparatus for connecting a device to a network, comprises: a scanning unit 401, for scanning for a broadcasted signal from a second device in a hot spot of the network; a communication unit 402, for connecting to the second device if the broadcasted signal is detected; and a data transmitting unit 403, configured for sending a network configuration information to the second device for connecting the second device to the network according to the network configuration information.

The scanning unit 401 scans for the broadcasted signal in the hot spot from the second device. If the scanning unit 401 can detect the broadcasted signal in the hotspot from the second device, the communication unit 402 connects to the second device through the broadcasted signal. After connecting to the second device, the data transmitting unit 403 sends the network configuration information to the second device for connecting the second device to the network according to the network configuration information, wherein the network configuration information includes authentication information of accessing the network or information for connecting to the network. And the network configuration information further includes information of the first device's hardware or of upgrading program for the second device. The second device gets the local network connection information according to the network configuration information. The second device can also execute other operations through other information comprised in the network configuration information, such as using the upgrade program to upgrade the software of the device. In a practical case, parts of this embodiment can be integrated. As long as the functions are similar (or the same) with the functions mentioned in the embodiment, it is comprised in the features of the present invention. For example, the first device of the present invention can be composed of WI-FI transceivers and controllers.

The present invention comprises: scanning unit 401 searches for the broadcasted signal in the hot spot from the second device. If the broadcasted signal is detected, the communication unit 402 connects to the second device through the broadcasted signal. And then the data transmitting unit 403 sends the network configuration information to the second device for connecting the second device to the network according to the network configuration information. The advantage of the apparatus mentioned above is that the control device can connect to the device which has just joined the network conveniently and send the authentication information of the local network to the device that just joined. This allows the device to join and be configured automatically which reduces the amount of manual operation.

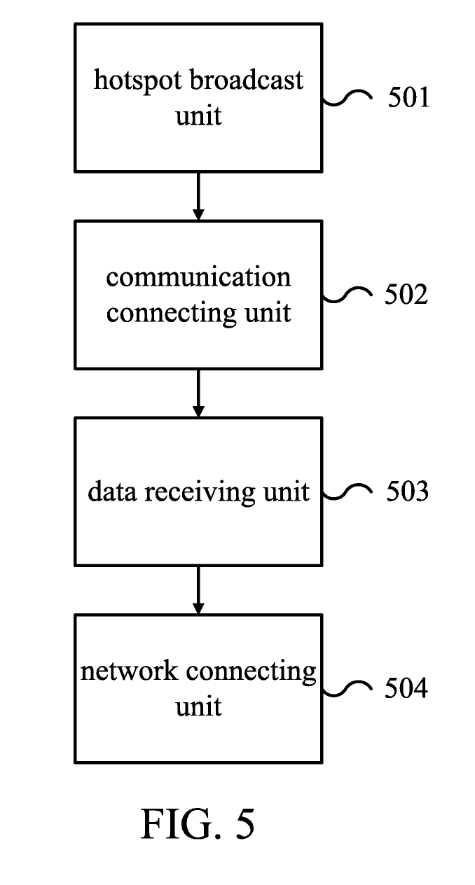

Please refer to FIG. 5. FIG. 5. is a function block diagram of the second device for connecting a device to a network in an embodiment of the invention. In this embodiment, the apparatus for connecting a device to a network comprises: a hotspot broadcast unit 501, used for performing a broadcast in a hot spot of the network; a communication connecting unit 502, used for connecting to a first device if detecting a request for connection from the first device through the broadcast; a data receiving unit 503, used for receiving a network configuration information sent from the first device; and a network connecting unit 504, used for connecting to the network according to the network configuration information.

The hotspot broadcast unit 501 broadcasts the network hotspot for other devices to connect to the device. The communication connecting unit 502 connects to the first device if detecting a request for connection from the first device through the broadcast. After the connection, the data receiving unit 503 receives the network configuration information sent from the first device, wherein the network configuration information includes authentication information for accessing the network or information for connecting to the network. After getting the network configuration information, the network connecting unit 504 connects to the network according to the network configuration information, for example, connecting to the local Wi-Fi network. In practical cases, parts of this embodiment can be integrated. As long as the functions are similar (or the same) with the functions mentioned in the embodiment it is comprised in the features of the present invention. For example, the second device of the present invention can be composed of Wi-Fi transceivers, Wi-Fi AP devices, and controllers.

This embodiment comprises the following: a hotspot broadcast unit 501 is used for performing a broadcast in a hot spot of the network. A communication connecting unit 502 is used for connecting to a first device if detecting a request for connection from the first device through the broadcast. A data receiving unit 503, used for receiving the network configuration information sent from the first device. A network connecting unit 504 is used for connecting to the network according to the network configuration information. The advantage of the apparatus mentioned above is that other control devices can send the network configuration information to the device through the broadcasted signal. The device can then log onto the network according to the information comprised in the network configuration information. This allows the device to join and be configured automatically which reduces the amount of manual operation.

Additionally, the second device for connecting a device to a network in another embodiment of the invention will be described in the following. In this embodiment, the apparatus for connecting a device to a network further comprises a storage unit, used to store the network configuration information. After the device connects to the network according to the network configuration information, the storage unit can store the network configuration information to use for the next time it needs to logs in or to send the network configuration information to other devices.

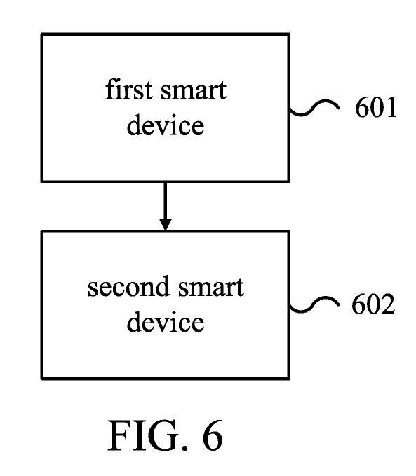

Please refer to FIG. 6. FIG. 6 is a function block diagram for connecting a device to a network system in an embodiment of the invention. In this embodiment, the system for connecting a device to a network comprises: a first smart device 601; and a second smart device 602, used for connecting to the first smart device 601 through a broadcasted signal and receiving a network configuration information sent from the first smart device 601, and then connecting to the network according to the network configuration information. Among them, the first smart device 601 is used to scan for the broadcasted signal from the second smart device 602 and then connecting to the second smart device 602 to send the network configuration information to the second smart device 602, wherein the network configuration information includes authentication information for accessing the network or information for connecting to the network.

This embodiment comprises the following: the first smart device 601 is used to scan for the broadcasted signal from the second smart device 602 and then connecting to the second smart device 602 to send the network configuration information to the second smart device 602. The second smart device 602 is connected to the first smart device 601 through the broadcasted signal and receives the network configuration information sent from the first smart device 601. The second smart device 602 can then connect to the network according to the network configuration information. The advantage of the system mentioned above is that it allows the original device to send the local network configuration information to the device that recently joined the network through the broadcasted hotspot. The recently joined device can then log onto the local network according to the information comprised in the network configuration information. This allows the device to join and be configured automatically which reduces the amount of manual operation.

Furthermore, the system for connecting a device to a network in another embodiment of the invention will be described in the following. In this embodiment, the system for connecting a device to a network further comprises: a remote device, used to connect to the second smart device 602 through the network and to receive the network configuration information sent form the second smart device 602, and then monitoring the second smart device 602. After the second device connects to the network, the second device can further send the network configuration information to the remote device, wherein the network configuration information comprises hardware information, working state, error messages, etc. The remote device can monitor the state of the second device through receiving corresponding information from the second device, wherein the remote device can be a remote server or the first device. Because the functions of them are similar, they will not be listed here.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

1. A method for connecting device to a network, the method comprising:
scanning for a broadcasted signal from a second device in a hot spot of the network with a first device;
connecting the first device to the second device through the broadcasted signal if the broadcasted signal is detected; and
sending a network configuration information by the first device to the second device, for the second device to connect to the network according to the network configuration information.

2. The method of claim 1, wherein the network configuration information includes authentication information of accessing the network or information for connecting to the network.

3. The method of claim 2, wherein the network configuration information further includes information of the first device's hardware or of upgrading program for the second device.

4. A method for connecting device to a network, the method comprising:
performing a broadcast in a hot spot of the network;
connecting to a first device, if detecting a request for connection from the first device through the broadcast;
receiving a network configuration information from the first device; and
connecting to the network according to the network configuration information.

5. The method of claim 4, wherein upon receiving the network configuration information from the first device, the method further comprising:
stopping the broadcast.

6. The method of claim 5, wherein after stopping the broadcast, the method further comprising:
performing the broadcast in the hot spot again, if the step of connecting to the network according to the network configuration information fails.

7. The method of claim 4, wherein after connecting to the network according to the network configuration information the method further comprising:
storing the network configuration information.

8. The method of claim 4, wherein upon connecting to the network according to the network configuration information, the method further comprising:
sending the network configuration information to a remote device through the network; and
the remote device performing a monitoring operation according to the network configuration information.

9. The method of claim 4, wherein upon connecting to the network according to the network configuration information, the method further comprising:
scanning for a broadcasted signal from a second device in the hot spot of the network with a first device;
connecting the first device to the second device through the broadcasted signal, if the broadcasted signal is detected;
sending the network configuration information by the first device to the second device; and
connecting to the network by the second device according to the network configuration information.

10. The method of claim 9, wherein after connecting to the network by the second device according to the network configuration information, the method further comprising:
connecting the second device to a third device if a hotspot broadcasted signal from the third device is detected;
sending the network configuration information by the second device to the third device; and
connecting the third device to the network according to the network configuration information.

11. The method of claim 4, wherein the network configuration information includes authentication information of accessing the network or information for connecting to the network.

12. The method of claim 11, wherein the network configuration information further includes information of the first device's hardware or of upgrading program for the second device.

13. An apparatus for connecting device to a network, comprising:
a scanning unit used for scanning for a broadcasted signal from a second device in a hot spot of the network;
a communication unit used for connecting to the second device if the broadcasted signal is detected; and
a data transmitting unit used for sending a network configuration information to the second device for connecting the second device to the network according to the network configuration information.

14. The apparatus of claim 13, wherein the network configuration information includes authentication information of accessing the network or information for connecting to the network.

15. The apparatus of claim 13, wherein the second device is a smart device such as a smart air conditioner, a smart refrigerator or a smart TV.

16. An apparatus for connecting device to a network, comprising:
a hotspot broadcast unit, used for performing a broadcast in a hot spot of the network;
a communication connecting unit, used for connecting to a first device if detecting a request for connection from the first device through the broadcast;
a data receiving unit, used for receiving a network configuration information sent from the first device; and
a network connecting unit, used for connecting to the network according to the network configuration information.

17. The apparatus of claim 16, further comprising:
a storage unit, used for storing the network configuration information.

18. The apparatus of claim 16, wherein the network configuration information includes authentication information of accessing the network or information for connecting to the network.

19. The apparatus of claim 18, wherein the network configuration information further includes information of the first device's hardware or of upgrading program.

20. The apparatus of claim 16, wherein the first device is a smart device such as a smart air conditioner, a smart refrigerator or a smart TV.
